(19) United States
(12) Patent Application Publication
(10) Pub. No.: US 2013/0257705 A1
(43) Pub. Date: Oct. 3, 2013

(54) Backlight Module and LCD Device

(71) Applicant: Yajun Yu, Shenzhen (CN)

(72) Inventor: Yajun Yu, Shenzhen (CN)

(21) Appl. No.: 13/503,096

(22) PCT Filed: Mar. 30, 2012
(86) PCT No.: PCT/CN12/73323

§ 371 Date: Apr. 20, 2012

(30) Foreign Application Priority Data
Mar. 27, 2012 (CN) 201210082715.7

(51) Int. Cl. G09G 3/36; F21V 29/00; G09F 13/18

(52) U.S. Cl. 345/102; 362/613; 362/612

(57) ABSTRACT

The invention provides a backlight module and an LCD device. The backlight module includes an LGP, point light source(s), and a backplane. The side wall of the backplane is provided with a pit extending to the outside of the backlight module relative to the light incident surface of the LGP, and the light sources are arranged on the pit. In the invention, because the position of the backlight module where the light sources are fixed is provided with the pit, the distance between the light source and the inner edge of the rubber frame is added due to pit, i.e. the A value is increased. Thus, the dark zones between every two LEDs of the light source can be effectively eliminated, and hotspot can be prevented from occurring in the active area of the LCD device. Meanwhile, after the A value is increased, corresponding A value can be selected to enable the frame of the LCD device to be narrowed, namely the A value is between the critical value that the hotspot cannot occur and the maximum A value obtained by the pit; thus, the frame of the LCD device becomes narrower, and the active area of the LCD device is increased.

### TECHNICAL FIELD

The invention relates to the field of liquid crystal displays (LCDs), and more particularly to a backlight module and an LCD device.

### BACKGROUND

As a key component of an LCD device, a backlight module is mainly used for providing sufficient brightness and uniformly distributed light sources, to enable an LCD panel to normally display images.

FIG. 1 shows a backlight module of an LCD device, including a backplane 100, a lightbar 140 fixed on the side wall of the backplane 100, a reflecting plate 110 arranged on the backplane 100, a light guide panel (LGP) 120 which is arranged on the reflecting plate 110 and opposite to the lightbar 140, a rubber frame 150 which is arranged outside the backplane 100 and used for pressing the LGP 120, and an outer frame 200; optical film(s) 130 is arranged on the light emitting surface of the LGP 120, and an LCD panel 300 is fixed above the backlight module by components of the rubber frame 150, the outer frame 200 and the like. With the development of narrower frames of LCD devices, the A value of the backlight module becomes smaller and smaller. The LCD devices generally employ point light source(s) such as LED(s) to provide sufficient brightness, resulting in some additional problems such as hotspot. As shown in FIG. 3, the A value is the distance from LED(s) 141 to the active area (AA area) of the LCD device, namely as shown in FIG. 1, the A value is the distance between the LED 141 and the end of the inner edge of the rubber frame 150. Because the A value is reduced, hotspot is generated. As shown in FIG. 3, because the A value is small, the light emitted by the LED 141 is emitted at a certain angle in the active area (AA area) of the LCD device close to the edge of the lightbar 140, and areas that light cannot shine between every two LEDs 141 form dark zones. Thus, the phenomenon that the dark and light zones (one light one dark) are alternatively arranged from top to bottom is hotspot, which seriously affects the optical quality of the backlight module and the display effect of the LCD device.

As shown in FIG. 2, U.S. Pat. Pub. No. US2010/0002418A1 discloses another backlight module, including a backplane 100, a heat conducting plate 190 closely attached to the backplane 100, a lightbar 140 fixed on the side wall of the backplane 100, an LGP 120 arranged opposite to LED(s) 142 of the lightbar 140, a reflecting plate 110 arranged below the LGP 120, and an outer frame 200 arranged outside the backplane 100; optical film(s) 130 is arranged on the light emitting surface of the LGP 120, and an LCD panel 300 is arranged above the backlight module. In addition, the backlight module further includes a support piece 170 which is used for supporting the reflecting plate 110 and the LGP 120 thereon. Thus, an air cavity 180 is formed between the heat conducting plate 190 and the reflecting plate 110 to play a role of heat insulation. Similarly, the backlight module of such a structure also faces the problem of the A value reduction resulted from narrower frames. If the design of narrower frames exceeds the allowed range of the A value, namely because the position of the LED 141 is fixed, the distance between the LGP 120 and the LED 141 will be reduced, and then the A value will be reduced; therefore, hotspot is formed in the active area of the LCD device, and thus the optical quality of the backlight module and the display effect of the LCD device are affected.

### SUMMARY

In view of the above-described problems, the aim of the invention is to provide a backlight module and an LCD device with a narrow frame and good display effect.

The aim of the invention is achieved by the following technical scheme. A backlight module comprises an LGP, a row of point light sources, and a backplane; the side wall of the backplane is provided with a pit extending to the outside of the backlight module relative to the light incident surface of the LGP, and the light sources are arranged in the pit.

Preferably, the pit on the side wall of the backplane is a through hole arranged in the side wall of the backplane. The through hole is easy to process, and facilitates the positioning of the light sources. By using the through hole to form the piton the side wall of the backplane, the light sources can be arranged in the through hole, and the A value of the backlight module is increased.

Preferably, the backlight module comprises a rubber frame; the side wall of the rubber frame is also provided with a pit in the position corresponding to the through hole. As the rubber frame is also provided with the pit, the A value of the backlight module is further increased.

Preferably, the backlight module comprises an outer frame; the pit on the rubber frame is a through hole arranged in the side wall of the rubber frame, and the light sources are arranged on the smooth side wall of the outer frame. The through hole is easy to process, and facilitates the positioning of the light source.

Preferably, the backlight module comprises an outer frame; the pit on the rubber frame is a through hole arranged in the side wall of the rubber frame. The side wall of the outer frame is provided with a lug boss extending to the inside of the backlight module in the position corresponding to the through hole in the side wall of the rubber frame. The depth of the lug boss is less than the total thickness of the side wall of the backplane and the side wall of the rubber frame, and the light sources are arranged on the lug boss. The aim of arranging the lug boss is to facilitate positioning when assembling the backlight module, and increase the assembling accuracy and efficiency.

Preferably, the pit on the side wall of the backplane is a bending on the side wall of the backplane, and the light sources are arranged on the bending. The bending arranged on the backplane to form the pit can avoid the strength reduction of the backplane relative to the through hole.

Preferably, the backlight module comprises a rubber frame; the side wall of the rubber frame is also provided with a pit in the position corresponding to the through hole, thereby increasing the A value of the backlight module.

Preferably, the pit on the side wall of the rubber frame is a through hole arranged in the side wall of the rubber frame, the bending on the side wall of the backplane is inserted in the through hole in the side wall of the rubber frame, and the light sources are arranged on the bending. The bending on the backplane is matched with the through hole in the rubber frame, to form the pit extending to the outside of the backlight module, thereby increasing the A value of the backlight module.

Preferably, the point light sources are an LED lightbar. LED has the advantages of high luminance and low energy consumption.

Preferably, the backplane is made of material with a good heat dissipation effect. Because the light sources are fixed on the backplane, and heat is dissipated via the backplane, the heat dissipation efficiency of the backlight module can be improved if the backplane is made of material with a good heat dissipation effect.

An LCD device comprises the aforementioned backlight module.

In the invention, because the side wall of the backplane of the backlight module of the invention is provided with the pit extending to the outside of the backlight module relative to the light incident surface of the LGP, and the light sources are arranged in the pit; the distance between the light source and the inner edge of the rubber frame is added due to the pit, i.e. the A value is increased. Thus, the dark zones between every two LEDs of the point light source can be effectively eliminated, and hotspot can be prevented from occurring in the active area of the LCD device. Meanwhile, after the A value is increased, corresponding A value can be selected to enable the frame of the LCD device to be narrowed, namely the A value is between the critical value that makes the hotspot cannot occur and the maximum A value obtained by the pit. Thus, the frame of the LCD device becomes narrower, and the active area of the LCD device is increased.

### BRIEF DESCRIPTION OF FIGURES

FIG. 1 is a simplified structure diagram of a conventional backlight module;

FIG. 2 is a simplified structure diagram of another conventional backlight module;

FIG. 3 is a schematic diagram of an A value and a hotspot area of a conventional backlight module;

FIG. 4 is a simplified structure diagram of a backlight module of example 1 of the invention;

FIG. 5 is a simplified structure diagram of a backlight module of example 2 of the invention;

FIG. 6 is a simplified structure diagram of a backlight module of example 3 of the invention; and

FIG. 7 is a schematic diagram of an A value and a hotspot area of a backlight module of example 1, example 2 and example 3 of the invention.

Legends: 100. backplane; 101. bending; 110. reflecting plate; 120. LGP; 130. optical film; 140. light source; 150. rubber frame; 170. support piece; 180. air cavity; 190. heat conducting plate; 141. LED; 142. PCB; 151. inner edge; 200. outer frame; 210. lug boss; 300. LCD panel.

### DETAILED DESCRIPTION

The invention will further be described in detail in accordance with the figures and the preferred examples.

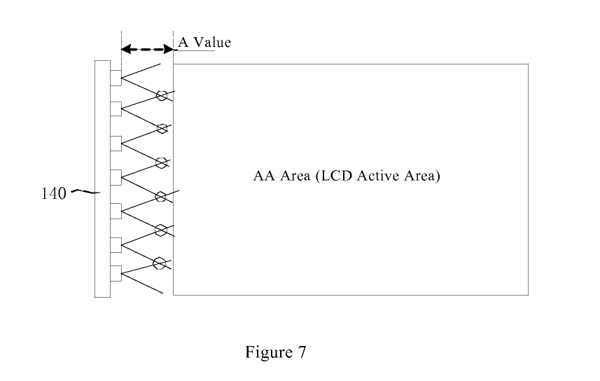

As shown in FIGS. 4-6, a backlight module of the LCD device of the invention comprises a backplane 100, a reflecting plate 110 arranged on the backplane 100, an LGP 120 which is arranged on the reflecting plate 110 and opposite to a lightbar 140, a rubber frame 150 which is arranged outside the backplane 100 and used for pressing the LGP 120, and an outer frame 200; optical film(s) 130 is arranged on the light emitting surface of the LGP 120, and an LCD panel 300 is fixed above the backlight module by components of the rubber frame 150, the outer frame 200 and the like. The side wall of the backplane 100 is provided with a pit extending to the outside of the backlight module relative to the light incident surface of the LGP. The lightbar 140 as point light sources is arranged in the pit and coupled with the LGP 120. The lightbar 140 is partially or fully positioned in the pit. The distance between the LED(s) 141 of the lightbar 140 and the inner edge 151 of the rubber frame 150 is increased due to the pit, i.e. the A value is increased. Thus, the dark zones between every two LEDs of the lightbar 140 can be effectively eliminated, and hotspot can be prevented from occurring in the active area (AA area shown in FIG. 7) of the LCD device.

The following examples are several preferred examples of the invention.

### EXAMPLE 1

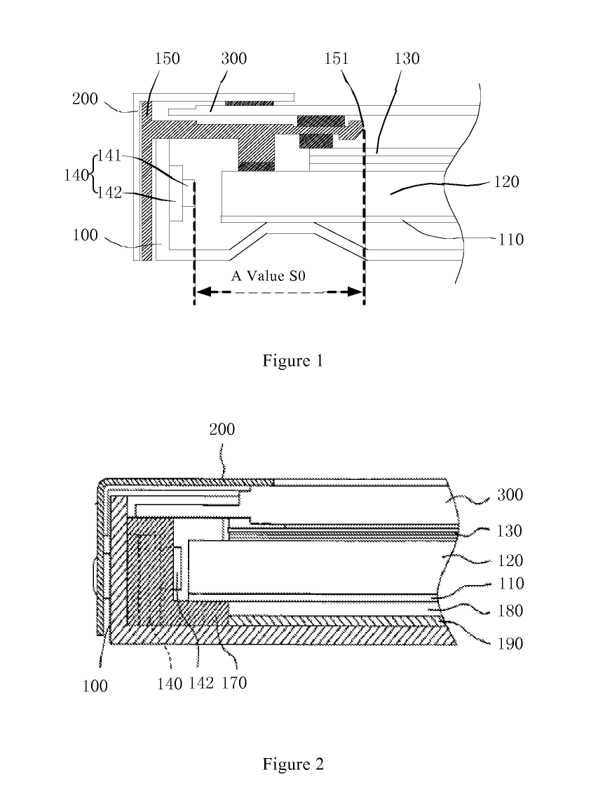

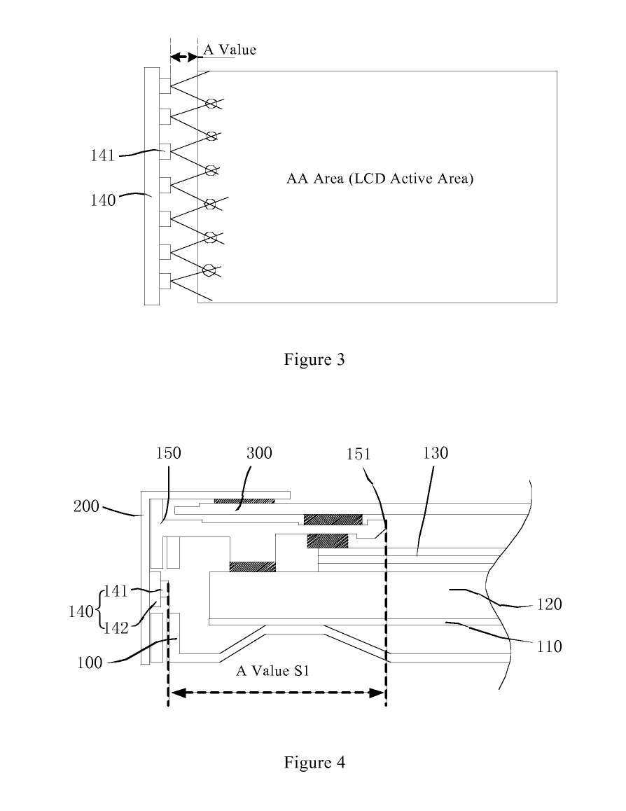

FIG. 4 shows example 1 of the invention. The backlight module of the LCD device comprises a backplane 100, a reflecting plate 110 arranged on the backplane 100, an LGP 120 which is arranged on the reflecting plate 110 and opposite to the lightbar 140, a rubber frame 150 which is arranged outside the backplane 100 and used for pressing the LGP 120, and an outer frame 200; optical film(s) 130 is arranged on the light emitting surface of the LGP 120, and an LCD panel 300 is fixed above the backlight module by components of the rubber frame 150, the outer frame 200 and the like. The side walls of the backplane 100 and the rubber frame 150 are provided with through holes which form a pit extending to the outside of the backlight module relative to the light incident surface of the LGP 120. The lightbar 140 as light sources is arranged in the pit and directly arranged on the smooth side wall of the outer frame 200 and attached to the side wall of the outer frame 200. Because the side walls of the rubber frame 150 and the backplane 100 are provided with through holes which form the pits, and the lightbar 140 is arranged in the pit, the distance between the lightbar 140 and the inner edge 151 of the rubber frame 150 is added, and then the A value is increased. Thus, the optical quality of the backlight module is increased, and the hotspot of the LCD device is eliminated. Alternately, the A value is more beneficial to the design of narrower frames when meeting requirement (namely hotspot does not occur). Suppose the thickness of the LED 141 is d1, the thickness of the printed circuit board (PCB) 142 is d2, the thickness of the side wall of the backplane 100 is d3, and the thickness of the side wall of the rubber frame 150 is d4; compared with the conventional backlight module as shown in FIG. 1, in the example, the A value is increased about S1=S1−S0=d3+d4; thus, the A value S1 in the example is increased by d3+d4 relative to the A value S0 of the conventional backlight module as shown in FIG. 1. Therefore, because the A value S1 is increased, dark zones occur outside the active area (AA area) of the LCD device as shown in FIG. 7, thereby increasing the optical quality of the backlight module and the display effect of the LCD device.

In the example, the aim of arranging the through holes which are difficult to process in the side walls of the backplane 100 and the rubber frame 150 instead of notches is to avoid weakening the structural strength of the backplane 100 and the rubber frame 150.

In the example, because the lightbar 140 is directly arranged on the outer frame 200, the outer frame 200 can be made of material such as aluminum material or other material with a good heat dissipation effect to increase the heat dissipation efficiency of the backlight module.

### EXAMPLE 2

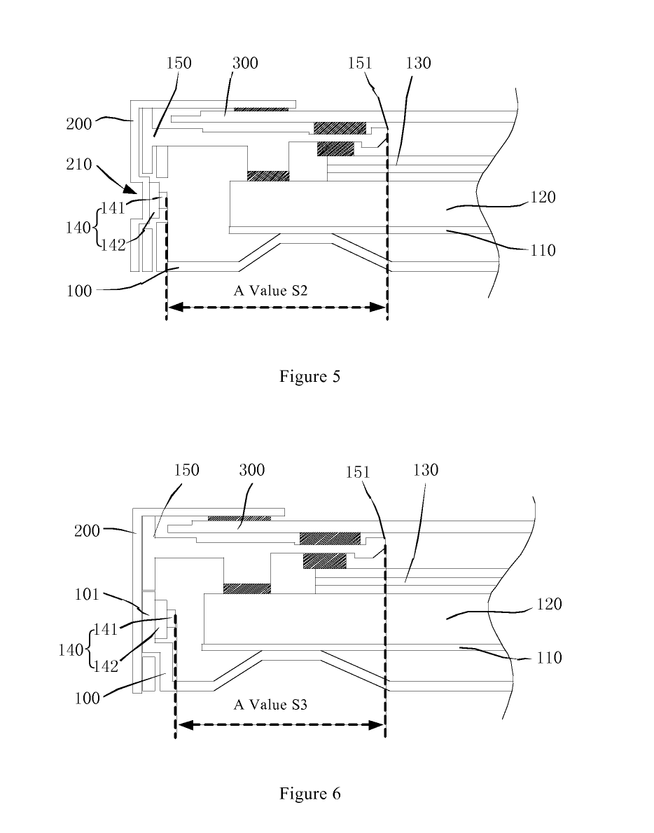

FIG. 5 shows example 2 of the invention. Example 2 is different from example 1 in that: in the example, the outer frame 200 is provided with a lug boss 210 extending to the inside of the backlight module in the position corresponding to the lightbar 140. The lug boss 210 corresponds to a pit formed by the through holes of the backplane 100 and the rubber frame 150. The depth of the lug boss 210 is less than the total thickness of the side wall of the backplane 100 and the side wall of the rubber frame 150, namely the lug boss 210 does not protrude from the pit surface of the pit, the bottom surface of the lug boss 210 is not flush with the pit surface, and the lightbar 140 is arranged on the bottom surface of the lug boss 210. The aim is to facilitate positioning when assembling the backlight module, and increase the assembling accuracy and efficiency. As shown in FIG. 5, the A value S2 of the backlight module of example 2 is increased about S2=S2−S0=d1+d2 relative to the A value S0 of the conventional backlight module shown in FIG. 1. Similarly, in this case, as shown in FIG. 7, dark zones formed between every two LEDs of the lightbar 140 occur outside the active area (AA area), thereby increasing the optical quality of the backlight module and the display effect of the LCD device.

Similarly, because the lightbar 140 is arranged on the outer frame 200, the outer frame 200 can be made of material such as aluminum material or other material with a good heat dissipation effect to increase the heat dissipation efficiency of the backlight module.

### EXAMPLE 3

FIG. 6 shows example 3 of the invention. In the example, the backlight module of the LCD device comprises a backplane 100, a reflecting plate 110 arranged on the backplane 100, an LGP 120 which is arranged on the reflecting plate 110 and opposite to the lightbar 140, a rubber frame 150 which is arranged outside the backplane 100 and used for pressing the LGP 120, and an outer frame 200; optical film(s) 130 is arranged on the light emitting surface of the LGP 120, and an LCD panel 300 is fixed above the backlight module by components of the rubber frame 150, the outer frame 200 and the like. The side wall of the rubber frame 150 is provided with a through groove in the position corresponding to the lightbar 140. The backplane 100 is provided with a bending 101 in the position. The bending 101 is inserted in the through groove of the side wall of the rubber frame 150, and the lightbar 140 is directly arranged on the bending 101 of the backplane 100. Thus, a pit extending to the outside of the backlight module relative to the light incident surface of the LGP 120 is formed in the position where the lightbar 140 is arranged, increasing the A value. Therefore, the hotspot is prevented from occurring in the active area (AA area) of the LCD device. As shown in FIG. 6, the A value S3 of the backlight module of example 2 is increased about S3=S3−S0=d3 relative to the A value S0 of the conventional backlight module shown in FIG. 1. Similarly, in this case, as shown in FIG. 7, dark zones formed between every two LEDs of the lightbar 140 occur outside the active area (AA area), thereby increasing the optical quality of the backlight module and the display effect of the LCD device.

In the example, because the lightbar 140 is arranged on the backplane 100, the backplane 100 can be made of material such as aluminum material or other material with a good heat dissipation effect to increase the heat dissipation efficiency of the backlight module; because the outer frame 200 is in direct contact with the backplane 100, the outer frame 200 can be made of material such as aluminum material with a good heat dissipation effect to add the heat dissipation path of the backlight module and increase the heat dissipation efficiency of the backlight module.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A backlight module, comprising: an outer frame, a rubber frame, an LGP, a row of point light sources, and a backplane; wherein the side wall of said backplane is provided with a bending, the side wall of said rubber frame is provided with a through groove in the position corresponding to said bending, the bending of the side wall of said backplane is inserted in the through groove of the side wall of said rubber frame, and said light sources are arranged on said bending.

2. A backlight module, comprising: an LGP, a row point light sources, and a backplane;
wherein the side wall of said backplane is provided with a pit extending to the outside of said backlight module relative to the light incident surface of said LGP, and said light sources are arranged in said pit.

3. The backlight module of claim 2, wherein the pit of the side wall of said backplane is a through hole arranged in the side wall of said backplane.

4. The backlight module of claim 3, wherein said backlight module comprises a rubber frame; the side wall of said rubber frame is also provided with a pit in the position corresponding to said through hole.

5. The backlight module of claim 4, wherein said backlight module comprises an outer frame; the pit of said rubber frame is a through hole arranged in the side wall of said rubber frame, and said light sources are arranged on the smooth side wall of said outer frame.

6. The backlight module of claim 4, wherein said backlight module comprises an outer frame; the pit of said rubber frame is a through hole arranged in the side wall of said rubber frame, the side wall of said outer frame is provided with a lug boss extending to the inside of said backlight module in the position corresponding to the through hole of the side wall of said rubber frame, the depth of said lug boss is less than the total thickness of the side wall of said backplane and the side wall of said rubber frame, and said light sources are arranged on said lug boss.

7. The backlight module of claim 2, wherein the pit of the side wall of said backplane is a bending on the side wall of said backplane, and the light sources are arranged on said bending.

8. The backlight module of claim 7, wherein said backlight module comprises a rubber frame; the side wall of said rubber frame is also provided with a pit in the position corresponding to said bending.

9. The backlight module of claim 8, wherein the pit on the side wall of said rubber frame is a through groove arranged on the side wall of said rubber frame; the bending on the side wall of said backplane is inserted in the through groove on the side wall of said rubber frame, said light sources are arranged on said bending, and said backplane is made of material with a good heat dissipation effect.

10. The backlight module of claim 1, wherein said point light sources are an LED lightbar.

11. An LCD device, comprising: a backlight module; wherein said backlight module comprises an LGP, a row of point light sources, and a backplane; the side wall of said backplane is provided with a pit extending to the outside of said backlight module relative to the light incident surface of said LGP, and said light sources are arranged in said pit.

12. The LCD device of claim 11, wherein the pit of the side wall of said backplane is a through hole arranged in the side wall of said backplane.

13. The LCD device of claim 12, wherein said backlight module comprises a rubber frame; the side wall of said rubber frame is also provided with a pit in the position corresponding to said through hole.

14. The LCD device of claim 13, wherein said backlight module comprises an outer frame; the pit on said rubber frame is a through hole arranged in the side wall of said rubber frame, and the light sources are arranged on the smooth side wall of said outer frame.

15. The LCD device of claim 13, wherein said backlight module comprises an outer frame; the pit on said rubber frame is a through hole arranged in the side wall of said rubber frame, the side wall of said outer frame is provided with a lug boss extending to the inside of said backlight module in the position corresponding to the through hole of the side wall of said rubber frame, the depth of said lug boss is less than the total thickness of the side wall of said backplane and the side wall of said rubber frame, and said light sources are arranged on said lug boss.

16. The LCD device of claim 11, wherein the pit on the side wall of said backplane is a bending arranged on the side wall of said backplane, and the light sources are arranged on said bending.

17. The LCD device of claim 16, wherein said backlight module comprises a rubber frame; the side wall of said rubber frame is also provided with a pit in the position corresponding to said through hole.

18. The LCD device of claim 17, wherein the pit on the side wall of said rubber frame is a through groove arranged on the side wall of said rubber frame; the bending on the side wall of said backplane is inserted in the through groove of the side wall of said rubber frame, and said light sources are arranged on said bending.

19. The LCD device of claim 18, wherein said backplane is made of material with a good heat dissipation effect.

20. The LCD device of claim 11, wherein said point light sources are an LED lightbar.
